(19) United States
(12) Patent Application Publication
(10) Pub. No.: US 2006/0097085 A1
(43) Pub. Date: May 11, 2006

(54) Device for supplying a medium to a cavitation-generating attachment

(76) Inventors: Sergiy Zakharchenko, Simferopol (UA); Andrew Fastovsk'yy, Simferopol (UA)

Correspondence Address: Ilya Zborovsky, 6 Schoolhouse Way, Dix Hills, NY, 11746, US

(21) Appl. No.: 11/184,648

(22) Filed: Jul. 19, 2005

(30) Foreign Application Priority Data
Jul. 21, 2004 (UA) 20040706061

(51) Int. Cl. B05B 1/08

(52) U.S. Cl. 239/589.1

(57) ABSTRACT

A device for supplying water to a hydrodynamic cavitation generating attachment has a body provided with a passage for supplying a medium which, during flowing through the passage, creates a reactive force, and a motor-driven unit for generating a force which counteracts the reactive force during operation of the device.

### BACKGROUND OF THE INVENTION

The present invention relates to devices (guns) for supplying a medium, such as water to a hydrodynamic cavitation-generating attachment, for example for cleaning surfaces of objects.

The devices of this type are used in combination with the above mentioned attachments, as disclosed for example in RU 2,123,957. The attachment is arranged on a device formed for example as a gun. One of such devices is produced by company Arkaian LLC as shown in WWW.AFT.COM.

The device has a main passage for supplying a medium, such as water, to the cavitation-generating attachment, and an additional passage for a return flow. During the operation for example under water, a medium is supplied to the main passage, bubbles are generated in the attachment, and when the flow contacts with the surface to be cleaned, the bubbles collapse and release energy for eroding foreign substances on objects. During the operation a reactive force is created in the direction opposite to the reaction of the supply of water and it pushes the device away from the surface to be cleaned. The return passage does not completely solve the problem of absorbing the reactive force.

### SUMMARY OF THE INVENTION

Accordingly, it is an object of the present invention to provide a device for supplying a medium to a cavitation-generating attachment, which eliminates the disadvantages of the prior art.

In keeping with these objects and with others which will become apparent hereinafter, one feature of the present invention resides, briefly stated, in a device for supplying a medium to a hydrodynamic commutation generating attachment, comprising a body provided with a passage for supplying a medium which, during flowing through the passage, generates cavitation bubbles and also creates a reactive force; and motor driven means for generating a force which counteracts the reactive force during operation of the device.

Another feature of the present invention resides, briefly stated, said motor driven means include an electric motor, and a screw (propeller) turnable by said electric motor.

Still another feature of the present invention resides, briefly stated, in that said screw has an axis of rotation which coincides with an axis of said passage provided on said body, or is laterally offset from the axis of said body and located laterally of the latter.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a view showing a device for supplying a medium to a hydrodynamic cavitation-generating attachment in accordance with one embodiment of the present invention; and

FIG. 2 is a view showing a device for supplying a medium to a hydrodynamic cavitation-generating attachment in accordance with another embodiment of the present invention.

### DESCRIPTION OF THE PREFERRED EMBODIMENTS

A device for supplying a medium to a hydrodynamic cavitation-generating attachment in accordance with the present invention is formed as a gun which is identified as a whole with reference numeral 1 and has a handle 3 provided with a control element 4 formed for turning on and turning off of the device. A passage 5 for supplying a medium, for example water, extends through the handle 3 and the body 2 toward a cavitation generating attachment 6. The cavitation generation attachment can be formed as well known in the art, for example as disclosed in RU 2,123,957. An element for allowing a medium supply into the passage 5 and interrupting the medium supply into the passage 5 is identified with reference numeral 7. It is arranged in the handle 3 and can be formed for example as a known on-off valve.

Means for counteracting a reactive force created during the operation of the device is further provided in the inventive device and identified as a whole with reference numeral 8. The counteracting means 8 is formed for creating a force which is directed in a direction of supply of the medium toward the attachment 6 or, in other words, opposite to a reactive force created during supply of the medium toward the attachment 6. The means A is formed as a motor-driven means operative for generating a propelling force for thrusting the device in a direction 8, which is opposite to a direction of the reactive force B.

In accordance with one embodiment of the present invention, the motor-driven, propelling force-generating means can include an electric motor 9 with a screw (propeller) 10 which is rotated by the electric motor, to create a force which counteracts the reactive force and acts in the direction A.

When the device is designed in accordance with the present invention, it is easier to operate the device since the user who holds the device in his hands does not have to apply an additional force for counteracting a reactive force of the device, since a reactive force of the device is compensated by the means 8, 9, 10.

In the inventive device, also a return medium passage 11 can be provided, for generating a return flow, which contributes to counteraction of the reactive force. A regulating device 12 can be arranged in this portion of the device to regulate the quantity of the medium supplied to the return passage 11.

A counterweight 13 can be further attached to the body 2 of the device, and can be composed of a heavy material, for example lead. The counterweight 13 restores a center of gravity on the handle of the gun, to facilitate handling of the device.

In accordance with another feature of the present invention, the control element 4, for example a trigger, operates so that when activated by a user, it simultaneously turns the medium supply-allowing/interrupting element 7 and the electric motor 9. As a result, when the control element 4 is activated, the medium starts flowing through the passage 5 creating a reactive force as explained herein above, and simultaneously the electric motor 9 rotates the screw 8 to counteract the reactive force.

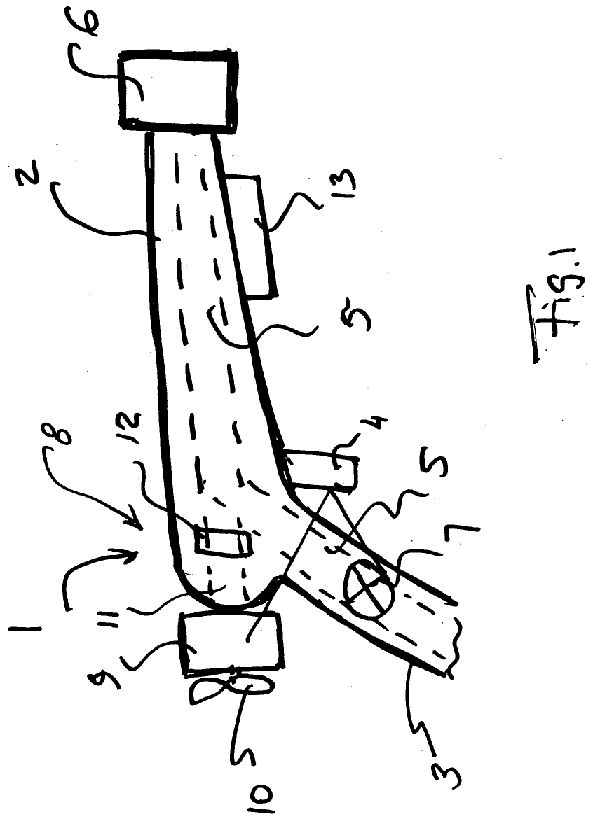

FIG. 2 shows another embodiment of the present invention. In this embodiment the device 1′ is formed substantially similar to the device 1 shown in FIG. 1. However, the reaction force compensating 8′ are formed in different manners. Here the reaction force compensating means 8′ comprise an electric motor 9′ and a screw (propeller) 10′ which are not coaxial with the passage 5 provided in the body 2, but instead has an axis which is parallel to an axis of the body 2. In other words, the means 8′, 9′, 10, are not coaxial with the body 2, but instead are radially offset from it.

It is to be understood that the device can be formed without a return medium flow, and with other elements which are immaterial for the present invention.

It will be understood that each of the elements described above, or two or more together, may also find a useful application in other types of constructions differing from the types described above.

While the invention has been illustrated and described as embodied in a device for supplying a medium to a hydrodynamic commutation-generating attachment, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A device for supplying water to a hydrodynamic cavitation generating attachment, comprising a body provided with a passage for supplying a medium which, during flowing through the passage, generates cavitation bubbles and creates a reactive force; and motor-driven means for generating a force which counteracts the reactive force during operation of the device.

2. A device as defined in claim 1, wherein said motor-driven means include an electric motor, and a screw turnable by said electric motor.

3-4. (canceled)

5. A device as defined in claim 1; and further comprising a handle connected with said body and forming an inlet part of said passage.

6. A device as defined in claim 1; and further comprising means for allowing entry of a medium flow into said passage and alternatingly preventing entry of the medium flow into said passage.

7. A device as defined in claim 6; and further comprising means for simultaneously activating said means for allowing and preventing and said motor-driven means.

8. A device as defined in claim 1; and further comprising a counterweight arranged on a part of said body.

9. A device as defined in claim 1, wherein said body has a return passage for providing a return flow of the medium for at least partially counteracting the reactive force.

10. A device as defined in claim 9; and further comprising means for regulating a quantity of a return flow of the medium through said return passage.
